(19) United States
(12) Patent Application Publication
(10) Pub. No.: US 2021/0220213 A1
(43) Pub. Date: Jul. 22, 2021

(54) Adjustable Abdominal Massage Apparatus and Method

(71) Applicant: Koekab, LLC, North Kansas City, MO (US)

(72) Inventors: Seyed Hamid Alhosseini, Overland Park, KS (US); Mohammad Kia, Plymouth, MI (US)

(73) Assignee: Koekab, LLC, North Kansas City, MO (US)

(21) Appl. No.: 17/271,336

(22) PCT Filed: Sep. 16, 2020
(86) PCT No.: PCT/US2020/070546

§ 371 Date: Feb. 25, 2021

Related U.S. Application Data
(60) Provisional application No. 62/901,449, filed on Sep. 17, 2019.

(51) Int. Cl. A61H 7/00; A61H 15/00

(52) U.S. Cl. CPC A61H 7/004; A61H 15/0078; A61H 2201/165; A61H 2201/1666; A61H 2201/0192; A61H 2201/1207; A61H 2205/083

(57) ABSTRACT

An apparatus and method for stimulating a patient's intestines based on observed anatomical structures for relief of chronic constipation. A rotating telescopic arm extends and retracts to move a stimulating mechanism around a customized path. The customized path is defined by a rail, track, or channel formed to match the patient's desired massage area. The stimulating mechanism is biased toward the patient to apply treatment through an adjustable, wearable belt.

### FIELD OF THE INVENTION

This disclosure relates to massage methods and devices, more particularly, to a massage method and apparatus with a customizable path, adjustable telescopic arm system, and a biasing mechanism which improves the continuous and automatic application of precise stimulation corresponding to the patient's precise internal anatomy, such as the colon path in the case of chronic constipation.

### BACKGROUND

Constipation is a common gastrointestinal complaint reported in people which includes symptoms such as decreased peristaltic reflex, infrequent stools, difficulty in defecation or hard stools as may be caused when sitting for extended periods when writing a patent application. One study in 2007 indicated approximately 33 million adults in the United States had constipation resulting in 2.5 million physician visits and 92,000 hospitalizations per year. Bowel problems due to chronic constipation has been linked to significant impairment on the quality of life.

Conventional treatment for chronic constipation includes pharmacological and nonpharmacological treatment. Pharmacological treatments include enemas and suppositories, bulking agents, osmotic and stimulant laxatives, stool softeners, and probiotics. Nonpharmacological treatments include healthy diet, exercise, increasing fluid and fiber intake, adequate time and privacy for bowel movements, attention to Gastrocolic reflex and biofeedback. Abdominal massage is another known nonpharmacological treatment having been used anciently and by multiple cultures in modern times as a form of constipation management. Abdominal massage has been linked to specific improvements that promote health and wellness, including pain relief, stress relief, reduction in gastrointestinal symptoms, and improvement of overall bowel function by simulating a variety of pressured movements to increase peristalsis and bowel sensation. Using abdominal massage as a form of constipation management eases the cost and side effects of pharmacological treatments. Abdominal massage also supplements the use of nonpharmacological treatments to improve the overall quality of life for constipation sufferers.

In common abdominal massage treatments, stimulation is provided by manual means necessitating the use of a clinician or travel to a treatment site by a patient. This approach requires the patient to obtain regular, burdensome, and expensive services to relieve chronic constipation. In addition, known self-operating massage apparatuses solve this problem only partially or in an overly complex way. These devices can be difficult to setup, operate, and maintain in proper working order.

### SUMMARY

The colon can be stimulated by pressure applied to the abdomen that mimics natural peristalsis and generally corresponds to the path of a patient's large intestine. The pressure applied generally corresponds to the path of the patient's large intestine in the direction of the ascending colon along the transverse colon and toward and along the descending and sigmoid colon. We recognized the disadvantage of known automated apparatuses where massaging is along an imprecise or fixed path. These shortcomings are a disservice to patients suffering from chronic constipation due to imprecise stimulation not corresponding to their unique anatomy. The current disclosure solves these drawbacks as well as provides a simple, affordable, portable, adjustable, and highly robust massage device to be used based on a patient's needs for improvement of constipation.

A customizable path or track may adjust the position of a stimulating mechanism, optionally via a telescopic arm system, to coincide the massage path that corresponds with the patient's anatomy. And a biasing mechanism may apply a continuous, precise amount of pressure corresponding to the contours of a patient's body surface, such as the abdominal wall, along the path.

A small electric motor may be centrally located and embedded within a wearable belt so that the device is lightweight and unobtrusive to wear. A cylinder encasing a telescopic arm may prevent pinching of clothes and skin, as well as protects debris from interfering with the movement of the telescopic arm. A telescopic arm may comprise a proximal end mounted to the motor, where the proximal end of the telescopic arm rotates with the motor to allow the stimulating mechanism to move about an irregular path. The telescopic arm may comprise a distal end adjustably mounted to the proximal end to extend and retract radially along the irregular path. At least one stimulating mechanism can be mounted near the distal end of the telescopic arm to follow the custom path, with the stimulating mechanism applies pressure to the patient. The distal end of the telescopic arm may be mounted to a custom track such that the telescopic arm radially extends and retracts to accommodate a variable radius between the motor and custom path. The custom path may be mechanically adjustable to correspond to a patient's anatomy through the interaction between the distal end of the telescopic path and a rail or track, specifically a bracket, wheel, bearing or other guide element on the distal end of the telescopic arm system wherein the bracket, wheel, bearing or other guide element is configured to direct the extension or retraction of the telescopic arm. A frame mounted to the adjustable massage apparatus may be configured with variable mounts that interlock with the rail or track made of malleable material such as rubber or steel. The belt may be comprised of a base comprising foam or fluid filled material for wrapping around the abdomen of a patient. A fastener on the belt may be configured to aid in adjusting tightness or looseness for application of tolerable stimulating massage pressure.

It is understood that other embodiments will become readily apparent to those skilled in the art from the following detailed description, wherein various embodiments are shown and described by way of illustration only. As will be realized, the concepts are capable of other and different embodiments and their several details are capable of modification in various other respects, all without departing from the spirit and scope of what is claimed as the invention. Accordingly, the drawings and detailed description are to be regarded as illustrative in nature and not as restrictive.

### DRAWINGS

Aspects are illustrated by way of example, and not by way of limitation, in the accompanying drawings, as follows.

FIG. 1A shows a top perspective view of an adjustable abdominal massage apparatus comprising two radial arms superimposed over a patient's torso showing an approximation of the large intestines.

FIG. 1B shows a top perspective view of an adjustable abdominal massage apparatus comprising three radial arms superimposed over a patient's torso showing an approximation of the large intestines.

FIG. 2A shows a path superimposed upon an example positioning of a patient's large intestines.

FIG. 2B shows a path superimposed upon an example positioning of a patient's large intestines.

FIG. 2C shows a path superimposed upon an example positioning of a patient's large intestines.

FIG. 3 shows an embodiment of the current disclosure with a cross-sectional side view of a telescopic arm and stimulating mechanism in cooperation with a custom path and frame system.

FIG. 4 shows a side view of an embodiment of the biased stimulating mechanism of FIG. 3.

FIG. 5 shows another embodiment of the current disclosure with a cross-sectional side view of a telescopic arm and stimulating mechanism in cooperation with a custom path and frame system.

FIG. 6 shows another embodiment of the current disclosure with a cross-sectional side view of a telescopic arm and stimulating mechanism in cooperation with a custom path and frame system.

FIG. 7A is a cross-sectional side view of a telescopic arm and stimulating mechanism in cooperation with a custom path and frame system and a biasing hinge joint and tension spring mechanism.

FIG. 7B is a cross-sectional top view of a telescopic arm and stimulating mechanism in cooperation with a custom path and frame system and a biasing hinge joint and tension spring mechanism.

FIG. 8A is a cross-sectional side view of another embodiment of the current disclosure comprising a cylinder spring within the cylinder housing and the wheel in cooperation with a rounded bar rail.

FIG. 8B is a cross-sectional side view of another embodiment the current disclosure comprising a partial distal end of the telescopic arm in cooperation with a slot-type rail within the frame.

FIG. 9A is a cross-sectional side view of another embodiment of the current disclosure showing a telescopic arm and stimulating mechanism in cooperation with a custom path and frame system.

FIG. 9B is a cross-sectional side view of another embodiment the current disclosure comprising a partial distal end of the telescopic arm in cooperation with a slot-type rail within the frame.

FIG. 10 shows a flowchart describing a method for adjusting a custom path.

FIG. 11 shows a flowchart describing a method for application of abdominal massage by the current disclosure.

FIG. 12 shows a side-perspective view of a portion of the massage apparatus separated from the custom path and frame;

FIG. 13 shows a side-perspective view of a portion of the massage apparatus separated from the custom path and frame;

FIG. 14 shows a top-side perspective view of a portion of the massage apparatus separated from the custom path and frame;

FIG. 15 shows a top-side perspective view of a portion of the massage apparatus in cooperation with the customizable track; and

FIG. 16 shows a flowchart describing a method for producing and using a track for an abdominal massage apparatus; and

FIG. 17 shows a top plan view of the circuitous custom path having variable radii for portions of the track.

### DESCRIPTION

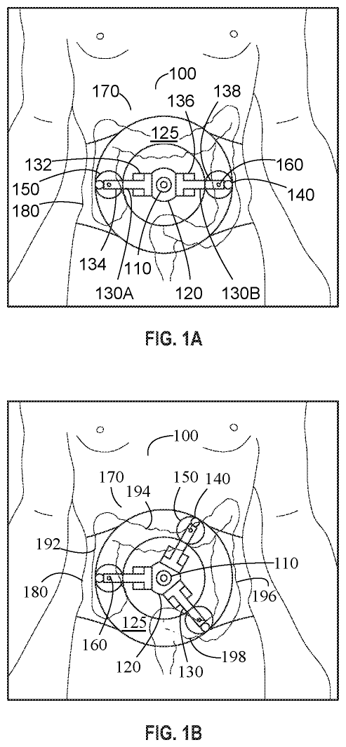

As shown in FIG. 1, abdominal massage is being administered to a patient 100 using an embodiment of the apparatus. According to this embodiment, the apparatus has a belt 180 comprised of an abdominal portion having an internal side and an external side. The belt 180 may comprise a base of foam or fluid filled material to provide comfort and avoid pressure contact between the biasing stimulating mechanism and the patient during massage treatment. The belt 180 may comprise a moldable base with a housing 120 for mounting the motor 110 to the belt 180. A custom path 125 corresponds to the general shape of a patient's large intestinal tract. The belt 180 comprises a motor 110. The motor 110 is centrally located within the treatment portion 170 of the belt 180. As illustrated in FIG. 1, a first telescopic arm 130A and a second telescopic arm 130B are configured to extend or retract radially from the motor 110. The first telescopic arm 130A has a first proximal arm portion 132 and a first distal arm portion 134. The second telescopic arm 130B has a second proximal arm portion 136 and a second distal arm portion 138. The distal arm portions 134, 138 may be biased outwardly or inwardly with respect to the proximal arm portions 132, 136. The distal arm portions 134, 138 cooperate with an adjustable rail, track, or channel mounted to a frame secured to or within the treatment portion of the belt 180. The rail, track, or channel may be adjusted up or down along different height portions of the frame. The variable height made by such adjustments allows the complimentary distal arm portions to move up or down while traversing the custom path. The distal arm portions 134, 138 may comprise a bracket, wheel, bearing, or guide 140 that is complementary with the adjustable rail, track, or channel. The telescopic arms also comprise a stimulating mechanism 150 attached to a supporting shaft 160. The stimulating mechanism 150 is illustrated as a ball and socket, alternative stimulating mechanisms are discussed below. The stimulating mechanism is driven about with circumferential movement induced by the motor 110 and the radial movement induced by the cooperation of the telescopic arms 130A, 130B and the adjustable rail, described below.

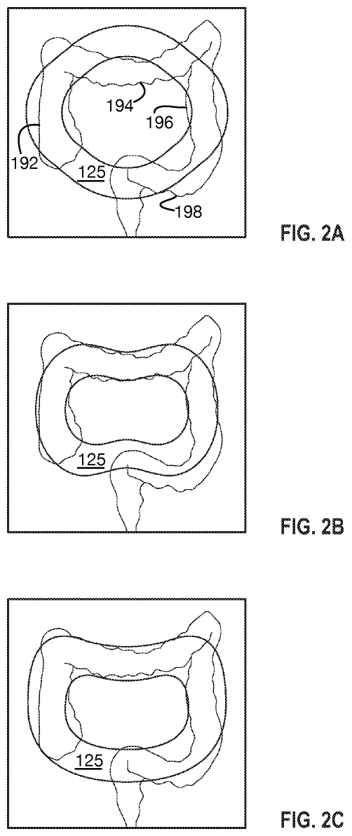

As shown in FIG. 2, the custom path follows the tract of the large intestine to stimulate the underlying tissues corresponding to the direction of natural movement of the bowel contents in the large intestine. The path follows the ascending colon 192 along the transverse colon 194 and toward and along the descending colon 196 and the sigmoid colon 198. FIG. 1B shows an apparatus having three telescopic arms. As illustrated in FIG. 1A and FIG. 1B, the pathway is circular and does not overlap with certain areas of the colon.

FIG. 2 shows several possible track shapes for the custom path 125 corresponding to the patient's internal anatomy. In FIG. 2A, the shape of the custom path is generally oval or diamond-shaped. In FIG. 2B, the shape of the custom path 125 comprises an oval form which are superiorly and inferiorly concave (i.e. peanut-shaped). In. FIG. 2C, the custom path 125 comprises lateral sides that are arcuate and a superiorly concave portion with flattened lower portion. Alternatively, the custom path 125 can comprise a superiorly or inferiorly concave portion (i.e. kidney-shaped), or other related shapes. The custom path may be determined after a patient examine, which may include internal imaging via radiography, ultrasound, or magnetic resonance. Internal imaging can be used to define the precise location and orientation of the patient's internal anatomy. A physical or aural examination may be employed in addition to or instead of the imaging. For example, the customized path 125 may be determined in relation to palpated bony landmarks that define the treatment area. Bony landmarks, such as the right- and left-anterior superior iliac spines (ASIS) of the pelvis, may be used for lateral-medial placement of the apparatus of the belt 180 and sizing of the customized path 125 along the frontal plane. Other bony landmarks, such as the xiphoid process and pubic symphysis, may be used for superior-inferior placement of the apparatus of the belt 180 and sizing of the customized path 125 along the transverse plane. The treatment portion 170 of the belt 180 may be moldable to precisely fit the custom path which may be circuitous or oval. The treatment portion 170 of the belt 180 may comprises foam or fluid filled material to provide comfort and avoid direct contact pressure from the stimulating mechanism against the skin of the patient.

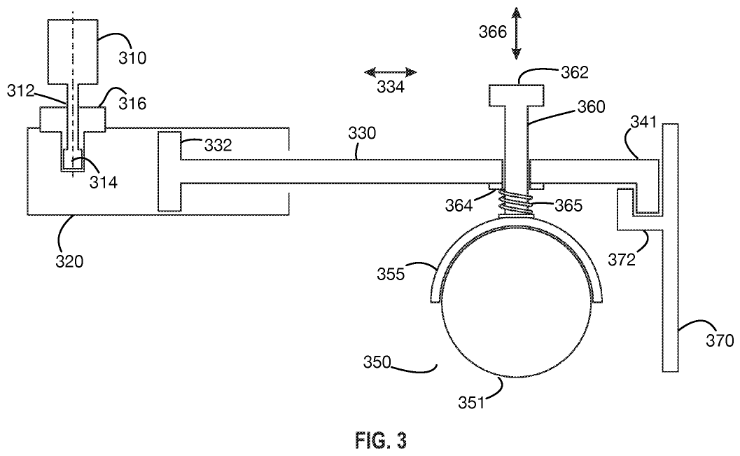

FIG. 3 shows an embodiment of the telescopic arm extending between the motor and the frame. The motor 310 is embedded within a belt housing 316. The belt housing 316 extends to be mounted to the belt, which is not shown in this view. When activated, a transmission shaft 312 rotates within the belt housing 316 with respect to the motor 310. Clockwise rotation (from a perspective anterior of the patient) of the transmission shaft 312 engages a transfer case 314 to also rotate clockwise. The transfer case 314 thereby gives the cylinder housing 320 rotational motion around the motor 310. The cylinder housing 320 encases the telescopic arm 330. Rotational motion of the telescopic arm 330 directs the stimulating mechanism 350 about the custom path. Telescopic arm 330 may have proximal end 332 disposed within the cylinder housing 320. The stimulating mechanism 350 is interlocked with the telescopic arm 330 by interlocking a supporting shaft 360 with retaining body 364 and retaining head 362. A spring 365 is stationed between the retaining body 364 and the stimulating mechanism 350 when the supporting shaft 360 is interlocked with the telescopic arm 330 to move rotationally and radially with the telescopic arm 330 while the supporting shaft 360 is able to move in a sagittal axis relative of the patient (shown by the double sided arrow 366 in FIG. 3). The stimulating mechanism 350 comprises the supporting shaft 360 connected to socket 355, which retains a ball 351. The stimulating mechanism 350 is rotationally moved about the custom path in the direction of the natural movement of the bowel contents in the large intestine. The stimulating mechanism 350 is driven with rotational motion around and by the central motor 310 mounted to the belt. The adjustable telescopic arm 330 system extends and retracts (as indicated by arrow 334) to accommodate the variable radius of the custom path between the central motor 310 and the rail 372. As the motor 310 drives the telescopic arm 330 about the custom path, a distal end 341 member of the telescopic arm 330 engages the rail 372. The telescopic arm 330 radially extends and retracts based on the distance between the motor 310 and a radial portion of the rail 372. The distance between the motor 310 and the radial portion of the rail 372 may range between approximately four to eight inches. The distal end 341 is complementary to and operably connected with rail 372. Rail 372 is mounted to frame 370. Frame 370 extends outwardly, generally parallel with a patient's sagittal axis, from the treatment portion of the belt. The belt may have a belt covering, made out of material such as fabric, vinyl, or plastic, that encompasses the treatment portion of the belt and the frame. Frame 370 may extend between the treatment portion of the belt and an external side of the belt covering. The frame may attach to the belt by Velcro, buttons, hooks and loops, interlocking studs and slots, or magnets. As illustrated in FIG. 3, the distal end 341 can comprise a generally L-shaped extension configured to be received and adjoined to a complementary inverted L-shaped rail 372 secured to the frame.

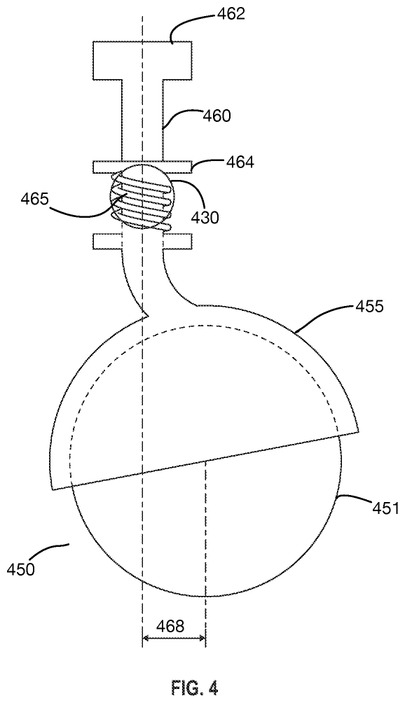

As shown in FIG. 4, in one embodiment of the current disclosure, the stimulating mechanism 450 comprises a ball 451 and socket 455 attached to one end of the shaft 460 which may be supported by the telescopic arm 430. The stimulating mechanism 450 is moved about the custom path with rotational force applied via the motor through the telescopic arm 430 and radial force through the interaction between the distal end of the telescopic arm and the customized path. The stimulating mechanism 450 comprises a ball 451 being a spherical bearing held within a socket 455 being a shell concavity. The spherical bearing may be held within the shell concavity by a pin, dowel, peg, or other coupling means that act as an axle on which the spherical bearing rotates around as the biasing stimulating mechanism is moved about the custom path. Alternatively, the stimulating mechanism may be nonrotating. The stimulating mechanism 450 may comprise a ball 451 being a spherical bearing or other round shape engaging a socket 455 that is a hollow outer case to receive or envelope approximately half of the ball 451. Alternatively, the shape of the stimulating mechanism 450 may be cylindrical, egg-shaped, knobbed, or have other smooth projections. The stimulating mechanism 450 can be made of a material such as foam, wood, plastic, or can be fluid filled. The stimulating mechanism as illustrated involve a physical stimulation based on the biasing of the stimulating mechanism toward the patient. The stimulating mechanism 450 may also comprise non-physical stimulating mechanisms such as electrical impulse, ultrasonic emitters, or thermotherapy. A physical stimulating mechanism may provide simplicity, flexibility, durability, low power consumption, and mobility along any given custom path.

FIG. 4 shows an embodiment of the stimulating mechanism 450 wherein the ball 451 has an offset 468 from the longitudinal axis of the biasing mechanism to direct the force behind the ball 451 as it rolls. The offset 468 may reduce friction between the ball 451 and the patient or the belt. Biasing of the stimulating mechanism toward the patient is accomplished with a shaft 460 and spring 465 mechanism. Biasing the stimulating mechanism 450 toward the patient allows the stimulating mechanism to exert the stimulating force upon the patient. The spring 465 surrounds shaft 460 and pushes the stimulating mechanism 450 towards the patient. The socket joint of the stimulating mechanism 450 and a retaining body 464 may restrain the travel of the spring 465 in its longitudinal axis. The shaft 460 is generally cylindrical in shape, with a mounting to the telescopic arm 430 that positions the stimulating mechanism 450 in a generally perpendicular angle to the telescopic arm 430. The shaft 460 has a first end and a second end. A retaining head 462 is mounted at the first end (retaining head is also shown in other figures as retaining head 562, 662, 862). The retaining head 462 keeps the shaft 460 interlocked with the telescopic arm. The stimulating mechanism is mounted at the second end. The pressure at which the ball 451 presses against the patient is determined by the compressional strength of the spring 465 and the distance of the spring extension. The patient contacting portion of the stimulating mechanism is encouraged toward the patient when the belt is worn by the patient. In addition to or instead of a mechanical spring, any number of biasing mechanisms known in the art could be substituted including but not limited to biasing via an electric, magnetic, pneumatic, or hydraulic actuator mounted to rotate and radially move with the telescopic arm. Alternatively, the proximal portion of the telescopic arm 430 may be pivotally mounted to the motor or cylinder housing, with the biasing mechanism mounted between the motor or cylinder housing and the distal end of the telescopic arm 430. The telescopic arm 430 mechanism may connect the stimulating mechanism with the central motor to rotate the stimulating mechanism. The stimulating mechanism may apply mechanical force to the patient through the base.

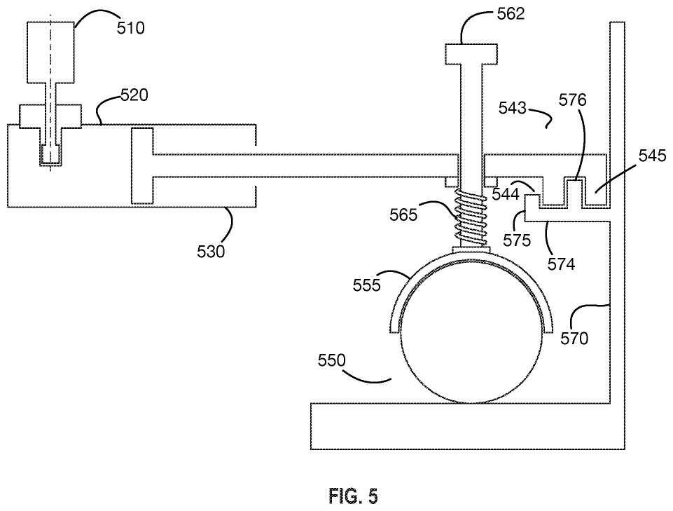

The distal end of the telescopic arm array cooperate with the customizable track to drive the stimulating mechanism 550, as shown in FIG. 5. The distal end 543 of the telescopic arm 530 may comprise a complementary keyed element to interact with and be guided by the rail 574. The rail 574 may be attached to the base via a frame 570. The telescopic arm 530 may have a proximal end disposed within cylinder housing 520. As illustrated in FIG. 5, the distal end 543 is shown as generally F-shaped. The rail 574 may also be generally F-shaped. For example, the rail has a first keyed element 575 that cooperates with keyed element 544 and a second keyed element 576 cooperates with keyed elements 544, 545. The rail 574 has a complementary shape (basically an inverted F-shape as well) with the first keyed element 575 and the second keyed element 576. The rail is secured to the frame. The distal end 543 and rail 574 may be made of a material such as rigid metal or plastic to direct the telescopic arm 530 to extend and retract about the customizable path for accommodating the variable radius between the central motor 510 and the custom path of the patient's massage area. It may be advantageous to use a low friction material, such as ultra-high molecular weight polyethylene (UHMW) or polytetrafluoroethene (Teflon). The stimulating mechanism 550 may comprise a socket 555. A biasing mechanism maintains the stimulating mechanism 550 toward the patient with spring 565. The biasing mechanism may have a retaining head 562.

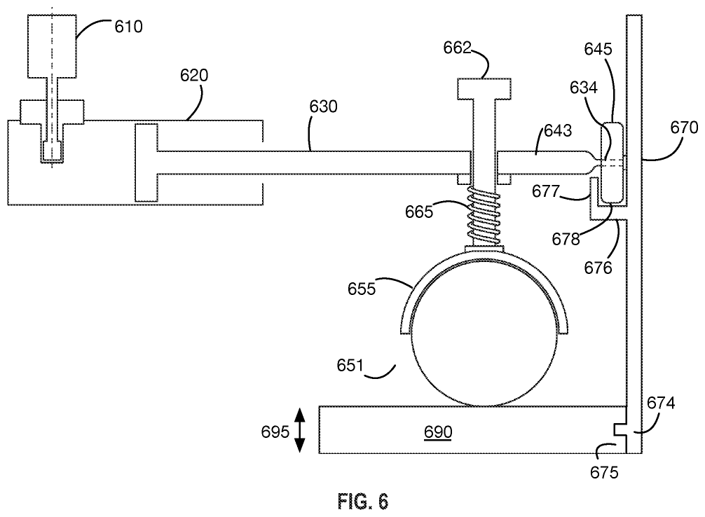

An embodiment of the guide mechanism where the distal end 643 comprises a rotating wheel 645 that travels within a track 676 mounted to the frame 670 is shown in FIG. 6. The telescopic arm 630 may have a proximal end disposed within cylinder housing 620. The distal end 643 of the telescopic arm 630 comprises a tapered hub 634 that operates as a shaft, rod, spindle, or axle. The tapered hub 634 is configured to be inserted into a wheel 645 to rotate about the longitudinal axis of the telescopic arm 630. The wheel's periphery is curved outward or convexly shaped. The wheel 645 rotates axially around the distal end 643 while moving within a track 676. The track 676 is shaped like a channel or a trough, with a proximal sidewall 677 and a floor 678. The track 676 is attached to the frame 670. Track 676 serves as a guide to direct the wheel 645. The telescopic arm 630 extends and retracts radially based on the variable radius between the central motor 610 and track 676. The distal end 643, wheel 645, and track 676 may be made of a material such as rigid metal or plastic, such as UHMW or Teflon. Alternatively, the wheel may be made of rubber, silicone rubber, or wood.

An embodiment is shown in FIG. 6 of a base mount 675 where the frame 670 is secured to a base 690 having variable height or thickness (arrow 695). The frame 670 may have a frame mount 674 that interlocks with the base 690 at a plurality of base mounts 675. The plurality of base mounts 675 and frame mounts 674 may comprise locks, clasps, cam lock nuts, dovetail joints, tenons and corresponding mortises, or other fastening means suitable to securing the frame 670 and the base 690 together. The stimulating mechanism may ride upon the base 690 having a variable height or thickness (arrow 695). The base 690 may incorporate an adjustable fluid bladder to provide changes in height or thickness (arrow 695). The fluid bladder may be pressurized by a fluid or depressurized to increase or decrease the thickness of the base, such as with liquid or air. A manometer may be connected to the bladder in order to display the pressure for consistency between treatments. An increase in thickness reduces the pressure from the stimulating mechanism. The increased or decreased thickness of the base 690 may affect the height of a corresponding track portion due to the frame 670 being raised or lowered. The bottom of the base 690 may be temperature controlled for further comfort of the patient receiving massage from the apparatus. The top of the base 690 may comprise a channel to aid in directing the stimulating mechanism about the custom path. Socket 655 retains a ball or spherical bearing which is one embodiment of the stimulating mechanism 651. The biasing mechanism may have a spring 665 and a retaining head 662.

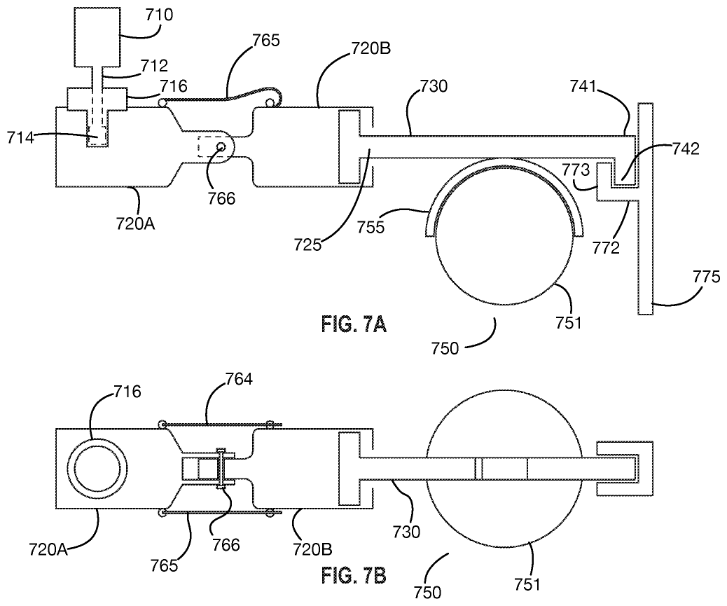

Multiple types of biasing mechanisms are envisioned, with a hinged embodiment shown in FIG. 7A. This embodiment comprises a cylinder housing 720A and a separate cylinder arm 720B portion. the cylinder housing 720A is separate from the telescopic arm 730. The telescopic arm 730 comprises a proximal end 725 and a distal end 741. A first tension spring 764 and a second tension spring 765 (shown in FIG. 7B) may cooperate with a hinge joint 766 to bias the telescopic arm 730 toward the patient. The height of a proximal sidewall 773 prevents the distal end 741 from escaping the track 772. The hinge joint 766 and cylinder arm 720B, in cooperation with the tension springs 764, 765, function operably as a third-class lever. The massage force is exerted at the distal end of the telescopic arm 730 through the stimulating mechanism 750 by the tension springs 764, 765. A single or multiple tension springs may be employed. As motor 710 is activated within belt housing 716, motor transmission shaft 712 rotates within belt housing 716 thereby engaging transfer case 714 to rotate cylinder housing 720A around transmission shaft 712. Cylinder housing 720A is coupled to telescopic arm 730 to rotate the telescopic arm 730 around the motor 710. Telescopic arm 730 thereby moves attached stimulating mechanism 750 about the custom path, with the motor 710 controlling the rotational movement and the telescopic arm's 730 extension and retraction controlling the radial distance between the motor 710 and the stimulating mechanism 750. Socket 755 retains a ball or spherical bearing 751 which is one embodiment of the stimulating mechanism 750. The stimulating mechanism 750 massages the patient along the custom path as directed by a complementary guiding mechanism. The complementary guiding mechanism on the distal end 741 of the telescopic arm 730 comprises a bracket 742 that is generally an L-shape. Bracket 742 is oriented and aligned to be received and adjoined to a track 772. Track 772 is shaped like a channel, with the proximal sidewall 773. The track 772 is securely attached to the frame 775. Track 772 serves as a pathway directing the telescopic arm 730 to extend and retract about the customizable path for accommodating a variable radius between the central motor 710 and track 772. The customizable path is defined to apply massage force through the stimulating mechanism 750 on the patient's desired massage area. The bracket 742 and track 772 may be made of a material such as rigid metal or plastic, such as UHMW or Teflon. The force at which the spherical bearing 751 presses against the patient is partially determined by the tension springs 764, 765.

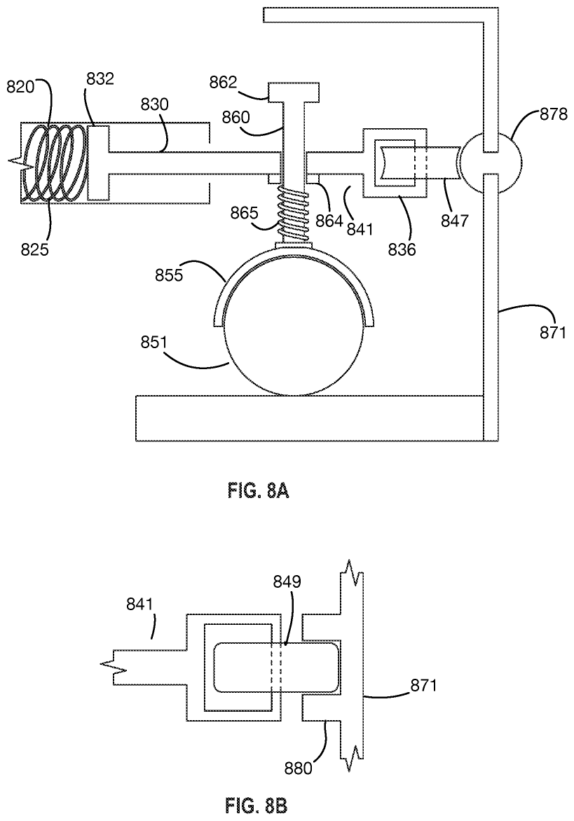

An alternative rail guide mechanism and cylinder spring are shown in FIGS. 8A and 8B. As illustrated, a retaining bracket 836 is mounted at a distal end 841 of telescopic arm 830. The retaining head 862 keeps the shaft 860 interlocked with the telescopic arm 830. The retaining bracket 836 comprises a wheel 847. Wheel 847 cooperates with rail 878 to guide the extension and retraction of telescopic arm 830. The wheel 847 is shown as having a concave tread that complements the spherical cross section of the rail 878. It is contemplated that the tread of the wheel 847 could have a flat, concave, or convex cross section to be paired with a complementary rail 878 or channel. The wheel 847 is orientated and secured longitudinally within the retaining bracket 836 having axle. Axle is shown extending in the patient's sagittal axis when the belt is applied to the patient's abdominal region. It is envisioned that the axle may be tilted such that the wheel is lower or higher than the rail. It is also contemplated that the wheel may extend outside of the frame, with the telescopic arm being inwardly biased to maintain traction between the wheel and the track. The retaining bracket 836 is mounted to the distal end 841 of the telescopic arm 830. The wheel 847, retaining bracket 836, and rail may be made of a material such as rigid metal or plastic, such as UHMW or Teflon. Alternatively, the wheel 847 may be made of rubber, silicone rubber, or wood. The telescopic arm 830 is shown encased within cylinder housing 820. The telescopic arm 830 rotates with the cylinder housing 820. The rail 878 is shaped like a rounded bar, shaft, rod, or cylinder. Socket 855 retains a ball or spherical bearing 851 which is one embodiment of the stimulating mechanism. The rail 878 may be made of a deformable material that is stiff but malleable such as moldable rubber, moldable silicon, moldable plastic, or steel. In one embodiment, the rail 878 comprises a castable material that may be heat treated or dry cured to form a stiff track capable of guiding the telescopic arm. A spring 865 is stationed between the retaining body 864 and the socket 855.

The rail guide may comprise a wheel 849 having a generally flat cross-section that cooperates with a track 880 having a U-shaped trough cross section, as shown in FIG. 8B. In this embodiment, the wheel 849 is shaped with a flat outward periphery that moves within the slotted track 880. Slotted channel 880 has a U-shaped cross section to receive and guide the wheel 849. The wheel 849 and track 880 may be made of a material such as rigid metal or plastic, such as Teflon or UHMW. The wheel 849 may also be made of rubber, silicone rubber, or wood. The track 880 is fastened to the frame 871 to provide structural support to the rail as the wheel radially pushes against it in transit about the custom path and to mount the track 880 to the belt.

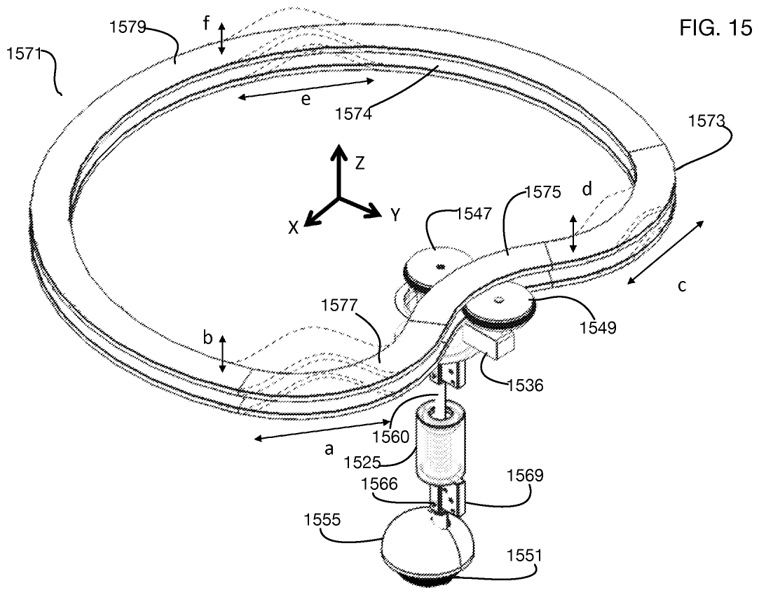

The frame may attach to the belt by Velcro, buttons, hooks and loops, interlocking studs and slots, or magnets. In one embodiment, the frame comprises modular rigid pieces that interlock together to form a custom frame shape. Individual rail pieces are shown in FIG. 15, with elements 1573, 1575, 1577, and 1579 each being an individual track portion. Each rail piece is attachable to one another to form a custom rail shape. Individual modular frame pieces may be installed through Velcro, buttons, hooks and loops, interlocking studs and slots, or magnets. Each individual modular frame piece may have its own shape, size, and height. For example, certain modular frame pieces may comprise straight sections and curved sections. In this way, the provider or patient can assembly a custom path based on the select modular frame pieces. A rail, track, or channel can be integrally formed into the modular frame pieces or can be attached to the frame. Alternatively, the frame itself can be fixed, and the rail, track, or channel can be deformable and adjustably mounted to the frame. For example, a bendable steel wire can be mounted to the frame as a rail, and the frame is mounted to the belt. The frame provides connection to the belt and support to maintain the rail. The fixed frame may support any number of bent configurations of the steel wire. The rail, track, or channel can also be molded and cured to form a custom rigid structure, which is then attached to the frame.

The height of the rail, track, or channel partially affects the massage pressure applied to the patient. The provider or patient can raise or lower the rail, track, or channel to increase or decrease (respectively) the massage force exerted by the stimulating mechanism.

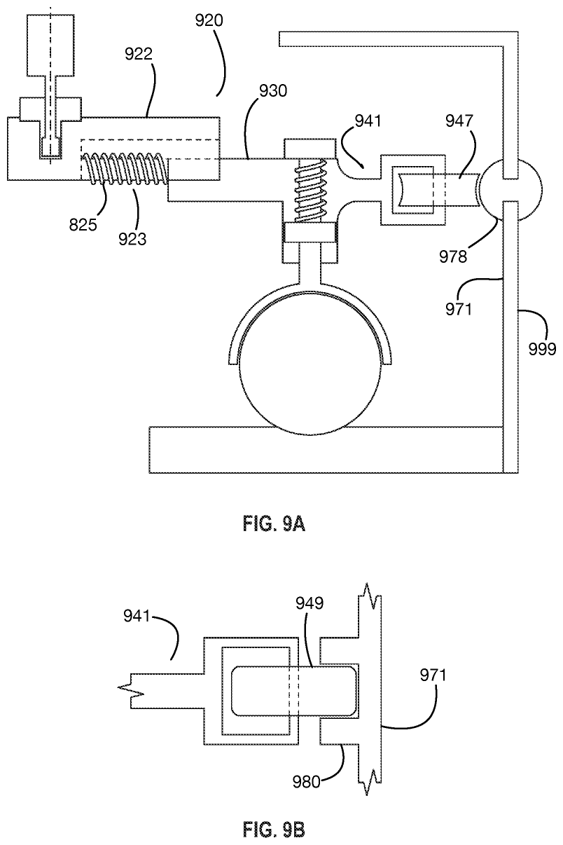

A compression spring 825 may be encased within the cylinder housing 820, 920 as shown in FIG. 8A and FIG. 9. Compression spring 825 provides an outward force against the proximal end 832 of the telescopic arm 830 of FIG. 8A and the proximal end of the telescopic arm 930 of FIG. 9 so that wheel 947, 949 engages the rail guide 980. It is also contemplated that the force upon the proximal ends of the telescopic arms 830, 930 could be an inward force, if the distal end 941 extended past the frame 871, 971 and the rail guide 980 was disposed outside of the frame against the exterior wall 999 of the frame. Alternatively, the cylinder housing may be fluidly pressurized to exert an outward force on the proximal end of the telescopic arm to radially extend or retract the telescopic arm 830, 930 to maintain contact with the rail 878, 978. Alternatively, an electric, hydraulic, pneumatic, or magnetic actuator can generate the outward pushing force on telescopic arm to radially extend or retract the telescopic arm to maintain contact with the rail.

The proximal telescopic arm portion 922 may receive a proximal end of the telescopic arm 930 as shown in FIG. 9A. The compression spring 825 is shown mounted upon and around a lower arm portion 923 that is partially received within the proximal telescopic arm portion 922. It is also contemplated that the compression spring 825 could be disposed within or around the proximal end of the telescopic arm 930.

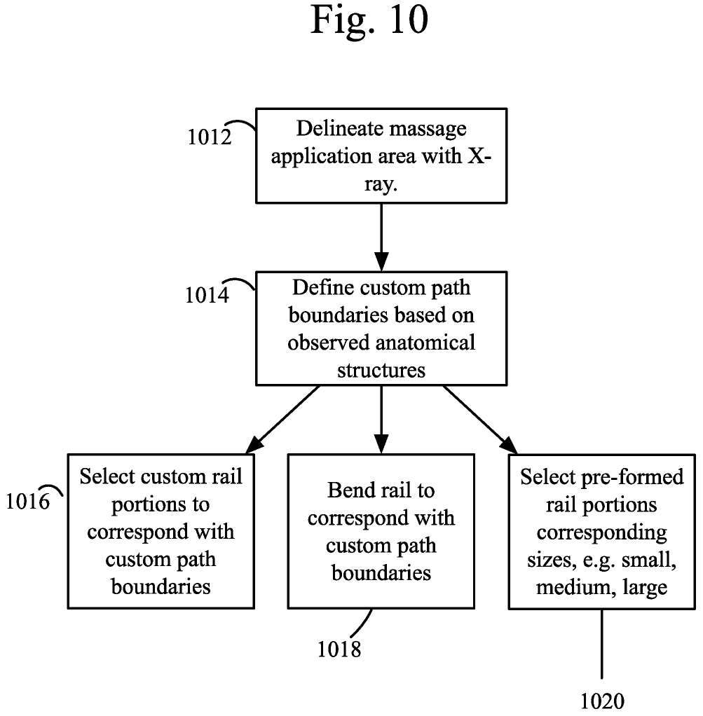

FIG. 10 shows the steps for a method of adjusting customizable path based on an examination of a patient. As shown in step 1012, the massage application area is first delineated. For example, the massage application area can be delineated through an internal imaging device such as with radiography, ultrasound, or magnetic resonance for defining the precise location and orientation of the patient's internal anatomy. Alternatively, a care provider can determine the general location and orientation of the patient's internal anatomy through physical examination such as a manual physical examination or an aural examination assisted with a stethoscope or other listening device. According to step 1014, the custom path boundaries can be defined with anatomical markers such as palpated bony landmarks that define the treatment area in cooperation with the imaging results of the manual physical or aural examination. According to step 1016, at least one portion of the track is selected from a plurality of track portions that may vary the length, width, height, radius, angle of curvature, total circumference of the rail or track of the adjustable abdominal massage apparatus. The specific rail portions are selected to correspond with the custom path that was determined based on the anatomical examination of the patient. In this embodiment, the customizable track is comprised of a plurality of interconnected portions that cooperate to form a complete circuitous path. Alternatively, according to step 1018, the track is determined by the shape of a wire connected to the frame and the wire is bent to correspond to the custom path that was determined based on the anatomical examination of the patient. Alternatively, according to step 1020, the customizable track can be selected from a pre-formed size paths, such as small, medium, and large.

While not shown in the illustrations, the apparatus may further comprise a timer unit to control the duration of the massage treatment. The timer may have preset treatment durations or be another timer mechanism configured to activate the motor for an adjustable period of time.

The motor unit may be powered by any suitable power source, for example: disposable battery, rechargeable battery, or a stationary power source like a household electrical outlet. It is also contemplated that the motor unit be powered by a simple spring-operated motor mechanism. In such an embodiment, the user would twist a lever connected to the motor to store mechanical energy. The stored mechanical energy could be stored in a spooled main spring. One possible advantage of a spring-operated motor mechanism is there would be no need for charging a rechargeable battery unit, replacing disposable batteries, or otherwise connecting the device to a power source.

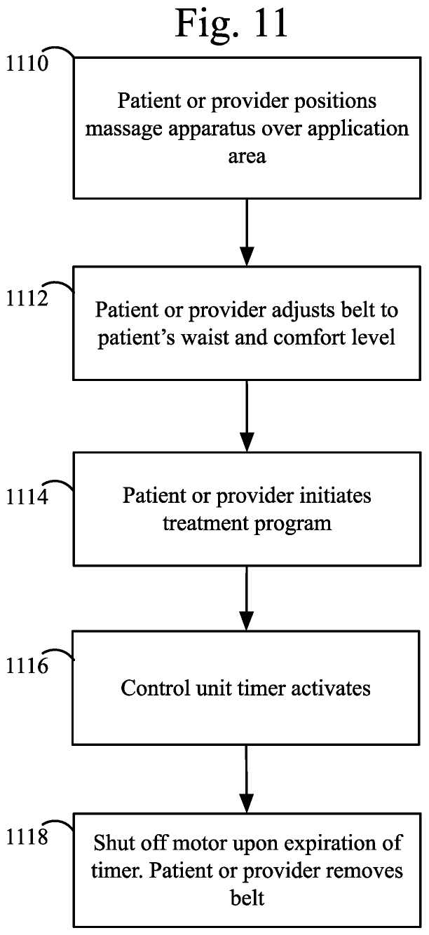

FIG. 11 shows the steps for a method of applying abdominal massage with an adjustable abdominal massage apparatus according to the current disclosure. According to step 1110, the patient or provider positions the massage apparatus over the treatment application area. According to step 1112, the patient or provider adjusts belt to patient's waist and comfort level. According to step 1114, the patient or provider initiates treatment program. According to step 1116, the control unit timer activates. According to step 1118, the motor shuts off upon expiration of the timer. The patient or provider removes the belt. This massage session is completed.

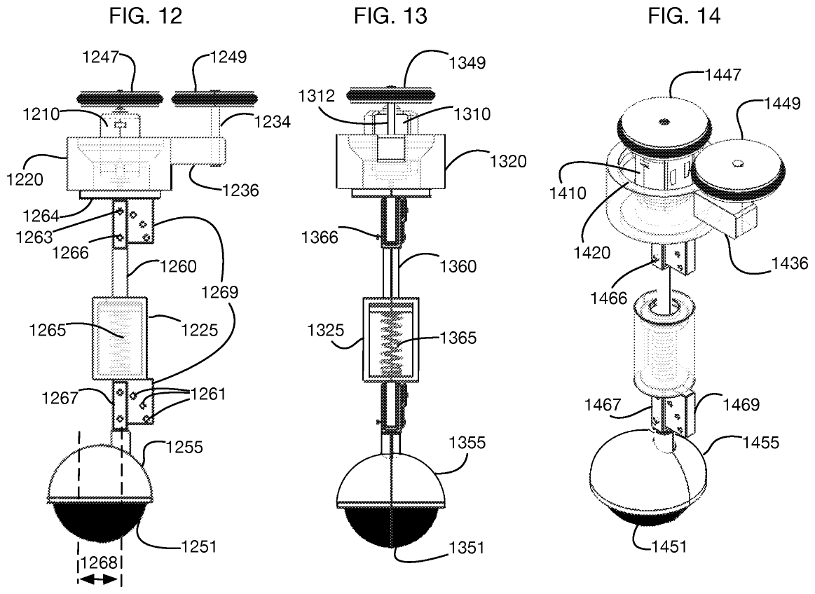

FIG. 12 shows a portion of the massage apparatus separated from the custom path and frame. The portion of the massage apparatus shown comprises a guiding mechanism, a drive mechanism, a pivot mechanism, a biasing mechanism, and a stimulating mechanism. The guiding mechanism may comprise a driven wheel 1247 (also driven wheel 1447, 1547), a backstop wheel 1249, a backstop wheel axle 1234, and a support housing 1236 (also support housing 1436, 1536). The driven wheel 1247 is connected to a motor 1210 of the drive mechanism. The drive mechanism may comprise the motor 1210, a motor housing 1220, and a retaining body 1264. The motor 1210 provides power to rotate and drive the driven wheel 1247 of the guiding mechanism. The motor 1210 is encased in the motor housing 1220. The motor housing 1220 (also motor housing 1320, 1420) is connected to the support housing 1236 that positions the backstop wheel 1249 (also backstop wheel 1349, 1449, 1549). The support housing 1236 provides a juncture point through which the backstop wheel axle 1234 is disposed. The length of the backstop wheel axle 1234 aligns the backstop wheel 1249 with the driven wheel 1247. The backstop wheel axle 1234 provides an axis of rotation for the backstop wheel 1249. A retaining body 1264 secures the motor housing 1220 of the drive mechanism to a retainer plate 1269 of a first pivoting mechanism. The motor housing 1220 facilitates the cooperation of the drive mechanism and the connected guiding mechanism with the track.

The pivoting mechanism may comprise a supporting shaft 1260, a retainer plate 1269 (also retainer plate 1469, 1569) having a plurality of positioning apertures 1261, a retainer clip 1267 (also retainer clip 1467) having a retainer pin 1263 and a pivot joint 1266 (also pivot joint 1366, 1466, 1566). The retainer plate 1269 holds the retainer clip 1267 in place when statically engaged. The retainer clip 1267 can engage the retainer plate 1269 when the retainer pin 1263 aligns with one of the positioning apertures 1261. The retainer pin 1263 engages a selected positioning aperture 1261 to hold the supporting shaft 1260 in place during massage treatment. The retainer pin 1263 may be a peg, bolt, or other cylindrical rod that may be inserted and disposed through the positioning aperture 1261. The retainer clip 1267 has a pivot joint 1266 that allows the retainer clip 1267 to disengage or engage with the retainer plate 1269. The retainer clip 1267 is pivotally moveable when indisposed from a positioning aperture 1261 and disengaged with the retainer plate 1269. The retainer clip 1267 and the aligned supporting shaft 1260 may be pivotally rotated around the pivot joint 1266. The retainer clip 1267 or retainer pin 1263 may be resiliently biased towards the retainer plate 1269 with a spring or other biasing device. A resiliently biased retainer clip 1267 or retainer pin 1263 may slide across the face of the retainer plate 1269 until brought into alignment with a selected positioning aperture 1261. The positioning apertures 1261 may be placed at various angles in relation to the pivot joint 1266 such as 0°, 15°, 30°, 45°, 60°, 75°, 90°, or other suitable angle for the intended application. The retainer clip 1267 and connected supporting shaft 1260 may be statically positioned at the various angles when engaged with a selected positioning aperture 1261. Selective adjustment of the supporting shaft 1260 may translate to adjustment of the connected biasing mechanism, the stimulating mechanism, or both.

Pivotal adjustment may provide for a foldable system. The foldable system may comprise the supporting shaft 1260, the retainer clip 1267, the biasing mechanism, and the stimulating mechanism. The total height of the system may increase or decrease based on the pivotal adjustment. Pivoting of the supporting shaft 1260 connected to the biasing mechanism and the stimulating mechanism may also direct the force of the biasing mechanism. Raising or lowering the stimulating mechanism with the foldable system may increase or decrease the force in relation to the patient's treatment area. A foldable system having pivotal adjustment may provide for increased patient comfort. A height adjustment of the stimulating mechanism by pivotal adjustment may be provided when patients have risk factors such as a diseased gall bladder, kidney failure, inflamed appendix, or enlarged spleen. The stimulating mechanism may also be pivoted toward or away from the center of a generalized patient treatment location. The distance from the center point of a treatment area may be dependent upon the installation position of the guiding mechanism upon the customizable track.

The biasing mechanism may comprise an end of the supporting shaft 1260, a spring 1265, and a spring housing 1225 (and spring housing 1325, 1525). The spring 1265 within the spring housing 1225 biases the stimulating mechanism towards a treatment area of a patient as compression of the spring against the end of the supporting shaft 1260 occurs. A spring 1265 may be chosen to have a suitable compressional strength chosen for the intended application. Alternatively, the spring 1265 may be replaced with pneumatic, hydraulic, air compression, screw drive, or other linear actuator to supply suitable pressure for the intended application. A second pivoting mechanism may be attached between the biasing mechanism and the stimulating mechanism. The second pivoting mechanism may be identical in structure and function to the first pivoting mechanism previously described.

The stimulating mechanism may comprise a supporting shaft 1260 (also supporting shaft 1360, 1560), a socket 1255 (also socket 1355, 1455, 1555), and a ball 1251 (also ball 1351, 1451, 1551) that is rotatable within the socket 1255 as previously described. The stimulating mechanism may be pivotally rotatable with respect to the biasing mechanism when a second pivoting mechanism is used. The second pivoting mechanism and the connected stimulating mechanism may be jointly biased towards the treatment area by the biasing mechanism. The socket 1255 is free to move about a longitudinal axis of the supporting shaft 1260 and may be fixed in other axis. The ball 1251 may also have a fixed central axis or a revolving horizontal axis. As shown in FIG. 12, the ball 1251 that is spherical may be made from material optionally comprising steel, plastic, wood or be air-filled or fluid filled. The ball 1251 may comprise other shapes such as oval, bean, or knobbed. The stimulating mechanism may comprise another stimulating device as previously described. Alternatively, the stimulating mechanism may comprise multiple massagers or massage heads. The massage heads may be interchangeable, radially adjustable, and comprise any of the previously discussed types for stimulation. The stimulating mechanism is moved about the custom path by the motor 1210 mounted to the track.

FIG. 12 shows a stimulating mechanism wherein the ball 1251 has an offset 1268 from the longitudinal axis of the supporting shaft 1260 to direct the force behind the ball 1251 as it rolls. The offset 1268 may reduce friction between the ball 1251 and the patient or the base. FIG. 13 shows a side-perspective with a 90-degree rotation from that of FIG. 12. In FIG. 13, the ball 1351 does not show the offset from the longitudinal axis of the supporting shaft 1360 when viewed at the 90-degree orientation from the side-perspective view of FIG. 12. FIG. 13 shows a vertical line of axis along the longitudinal axis of the supporting shaft 1360, where medial lines of the motor and the stimulating mechanism are aligned with the longitudinal axis. FIG. 13 also highlights a cross-sectional view of the spring 1365 implanted within the spring housing 1325. The spring housing 1325 may protect the spring 1365 from exterior interactions such as patient clothing, loose items, or debris. FIG. 14 shows a top-side perspective view of the portion of the massage apparatus. FIG. 14 highlights the motor 1410 implanted inside the motor housing 1420 shown in transparency. The motor housing 1420 supports the motor 1410 and may protect the motor from similar exterior interactions previously discussed.

FIG. 15 shows a portion of the massage apparatus in interaction with a track having variable height. The track 1571 may be made of track portions (individual track pieces) having varied shapes, sizes, and curvatures. The track 1571 may be comprised of materials such as molded rubber, rigid steel, molded plastics, or other durable materials. The track portions may be made to meet the desired track heights relative to the treatment area of a patient. The track 1571 may comprise varied cross sections such as C-shaped, L-shaped, or H-shaped depending on the design and the complimentary guiding mechanism. FIG. 15 shows a track 1571 with a H-shaped cross section. The complimentary guiding mechanism includes a driven wheel 1547 and a backstop wheel 1549 that are received within a trough 1574 found on either side of the track 1571. The backstop wheel axle 1234, 1312 spaces the backstop wheel 1549 away from the support housing 1536 at a distance to align the backstop wheel 1549 with the driven wheel 1547. The support housing 1536 may be of a length to separate the two wheels apart to accept the track 1571. The distance the wheels are spaced apart may correlate to the thickness of the track. The wheels may be made of rubber or similar durable material. The portion of the massage apparatus shown is installed with the driven wheel 1547 on the inside of the track 1571. An installation in this configuration may allow pivoting adjustment of the stimulating mechanism towards the center of a generalized patient treatment location. Alternatively, the driven wheel 1547 may be placed on the outside of the track 1571 allowing pivoting adjustment of the stimulating mechanism away from the center of a generalized patient treatment location. Total track length may need to increase or decrease based on the installation position of the guiding mechanism upon the customizable track. The driven wheel 1547 engages the track 1571 when the motor 1210, 1310, 1410 (obscured by the track in FIG. 15) is powered. The driven wheel 1547 and the backstop wheel 1549 are directed about by the contours of the track 1571 as the wheels ride within the trough 1574 of the track 1571. The track may be connected to a rigid frame through a riser mechanism (not shown). The riser mechanism may be configured to receive the track. The riser mechanism may provide for attachment of the track to the frame through attachment devices such as a toothed lock, curved foam, foam connector, or other attachment device suitable for the intended application. The riser mechanism may comprise a plurality of risers. The risers may be fixed to the frame at a set riser height or be made adjustable. The adjustable risers may be set on the frame at variable riser heights to support the track. Adjustment of the risers may be based on space parameters between the frame, track, and patient body.

As shown in FIG. 15, a motor (obscured by the track) may rotate the driven wheel 1547 in a clockwise direction (top perspective) thereby directing the portion of the massage apparatus shown in a counterclockwise direction about the track 1571. In a clockwise direction, the portion of the massage apparatus shown may start from the upper-mid track member 1575, going towards the first track member 1573, then the lower track member 1579, and finally the third track member 1577 in a continuous and repeating circuitous path. Alternatively, the motor may rotate the driven wheel 1547 in a counterclockwise direction thereby reversing the previously taken path to associate with the direction of bowel movements in a large intestine.

The stimulating mechanism may provide for varied degrees of stimulation pressure based on a track with varied height. In the example of an unmapped patient having a generalized patient treatment location, the stimulating mechanism may travel in the direction of the natural movement of the bowel contents in the large intestine as shown in FIG. 2. The stimulation pressure may increase over the ascending colon 192, decrease over the right-hand costal margin, increase along the transverse colon 194, decrease over the left-hand costal margin, increase over the descending colon 196 and sigmoid colon 198, decrease over the pubic symphysis, and repeat. In another example, the stimulation pressure may decrease in areas where less pressure is warranted due to an enlarged spleen, diseased gall bladder, inflamed appendix or over bony projections such as the costal margins, anterior iliac spines, or pubic symphysis that may lead to increased patient discomfort. In such cases, the stimulation pressure may decrease in the lower right quadrant over the appendix, increase over the ascending colon 192, eliminate over the right-hand costal margin, increase then decrease along the transverse colon 194, eliminate over the left-hand costal margin, increase over the descending colon 196 and sigmoid colon 198, eliminate over the pubic symphysis, and repeat.

As shown in FIG. 15, a track 1571 (with a x- and y-axis) lies generally within a horizontal plane. The horizontal plane may be parallel in relation to a frontal plane of a patient (not shown). The track 1571 that lies on the horizontal plane may be kidney shaped. Alternatively, the track may comprise shapes such as a circle, an ellipse, an oval, a peanut, or other shape intended to reflect positioning of a patient's internal anatomy along the frontal plane. A kidney shaped path is shown in FIG. 15. The diameter of the circuitous path may range between 150 millimeters (mm) to 300 mm (approximately six to twelve inches). In one case, the diameter of the circuitous path may range between 175 mm to 250 mm (approx. seven to ten inches) for an average medium-sized generalized patient treatment area. In another case, the diameter of the circuitous path may range between 150 mm to 225 mm (approx. six to nine inches) for an average small-sized generalized patient treatment area. In another case, the diameter of the circuitous path may range between 225 mm to 300 mm (approx. nine to twelve inches) for an average large-sized generalized patient treatment area. The track shape and diameter dimensions may have a clearance range of between 5 to 15 mm (approx. ¼″ to ½″) from anatomical landmarks identified by a local treatment provider. A clearance range allows the track to be within the boundary made by anatomical landmarks. In this case, the stimulating mechanism operating about the track may keep from overlapping any bony prominences, sensitive, or at-risk areas in the treatment area.

The track 1571 may be shaped with track portions having varied height relative to a sagittal axis (z-axis) of the patient. The sagittal axis may be an axis perpendicular to the patient's abdominal region. The portions with varied height may mold to fit the outline of a patient's body surface. Alternatively, the portions with varied height may be shaped to conform to the contour of a patient's internal anatomy. The dashed lines show variable arcuate curves having varied height relative to the z-axis. The variable arcuate curves on the track may correspond to one of any underlying left-hand costal margin, a right-hand costal margin, appendix, or other prominence. Such areas may bring discomfort to the patient if stimulated. An anterior convex curve above an associated prominence in the patient's treatment area may relieve stimulating pressure as the stimulating mechanism is guided about such track portion. Inversely, the track may have a posterior concave curve in a stimulation zone of the patient's treatment area such as the large intestine. The stimulating pressure from the stimulating mechanism may increase as the stimulating mechanism is guided about such track portion. The arcuate curves may have variable heights as shown by arrows b, d, and fin FIG. 15. The range of the variable heights of the arcuate curves associated with arrows b, d, and f may be between 0 mm and 50 mm (approx. 0 to 2 inches). The arcuate curve heights associated with arrows b, d, and f may be plus or minus 25 mm (approx. 1 inch) toward an anterior or posterior position of the track 1571. The dashed lines also show the variable arcuate curves having variable lengths (shown as arrows a, c, and e in FIG. 15). The range of the variable lengths of the arcuate curves associated with arrows a, c, and e may be between 50 mm and 100 mm (approx. 2 to 4 inches). The arcuate curve lengths associated with arrows a, c, and e may be plus or minus 25 mm (approx. 1 inch) depending on how small or large the surface area of the prominence is.

Imaging techniques may determine the x-y-z axis coordinates of the treatment area, internal or external, relative to coordinates mapped for a contour of a patient's treatment area. The x-y-z-axis coordinates of a treatment area may be mapped by a local treatment provider using imaging techniques such as X-ray, magnetic resonance imaging (MM), computed tomography (CT) scan, ultrasound, sonogram, 3-dimensional (3D) scanner, compressible foam, or other techniques. In one example, an X-ray of the patient's treatment area may be imaged. For example, the image may help the local treatment provider identify how low the transverse colon 194 is and how far left (patient's left) the sigmoid colon 198 is within the treatment area. Mapping the shape of internal anatomy with X-ray imaging may be easier and cheaper than other imaging techniques. Alternatively, a local treatment provider may simply conduct a physical examination to measure prominent points on a patient's body surface such as bony landmarks previously discussed. The variable x-y-z coordinates may be translated into diagnostic points. The diagnostic points may be submitted by a local treatment provider to a manufacturer for making the adjustable massage apparatus and custom track. One aspect of customization may include manufacture of custom components or track members for the track.

The track 1571 may be customizable by interlocking track members together as shown by a first track member 1573, an upper-mid track member 1575, a third track member 1577, and a lower track member 1579. Track members may interlock by varied means such as locks, clasps, cam lock nuts, dovetail joints, tenons and corresponding mortises, or other fastening means that meet the needs of joining the track members together. Track members may be produced by applications comprising 3-dimensional (3D) printing, stamping, pressing, thermosetting or other applications that are suitable for producing the track members. Track members for a track 1571 measured from an imaged custom path may have varied relative height relative to a patient treatment area. Less stimulation may be required for prominent treatment areas which may be close to the patient's body surface. The height of the track may be increased with a track member having an upward curve associated with an underlying prominent area along the z-axis. More stimulation may be required for inconspicuous treatment areas which may be deeper within the patient's body. The height of the track may be decreased with a downward curve associated with an inconspicuous treatment area along the z-axis. Track members may be selected from a variety of configurations having varied sizes, lengths, shapes, and dimensions. FIG. 15 shows a variety of track members being linked together. The first track member 1573, the upper-mid track member 1575, and the lower track member 1579 may have an outwardly convex shape from the center point of the treatment area. The third track member 1577 may have an inwardly concave shape from the center point of the treatment area. Other shapes may include right-angles, acute angles, obtuse angles, sinusoidal waves, upward curves, downward curves, or other shapes to meet the needs of the patient treatment area.

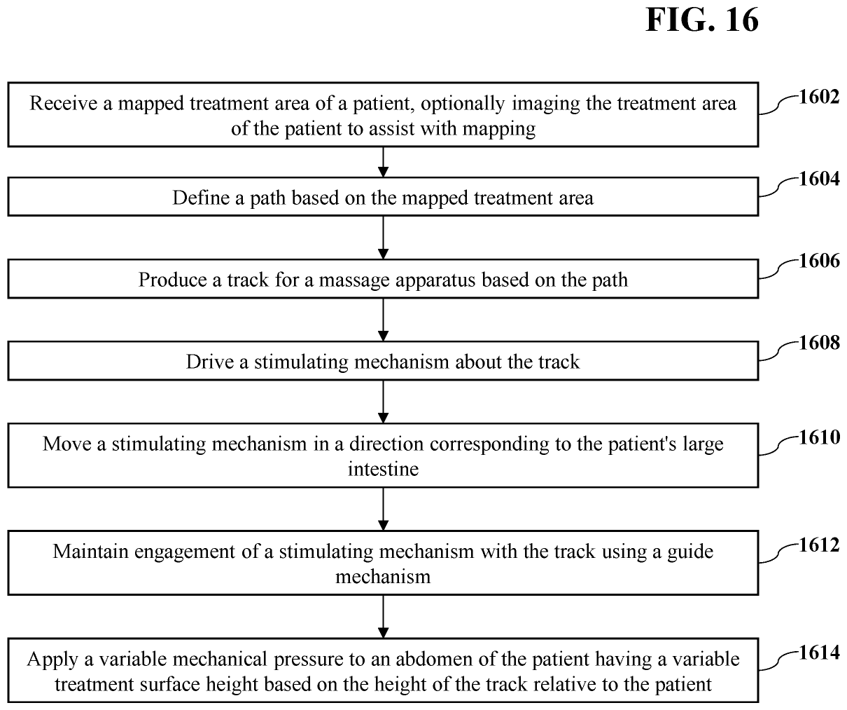

FIG. 16 shows the steps for producing and using a track for an abdominal massage apparatus. A manufacturer of the track receives a mapped treatment area of a patient, according to step 1602. The mapped treatment area may be provided to the manufacturer from scans, diagnostics, or other measurements by a local treatment provider. The local treatment provider may optionally image the treatment area of the patient to assist with mapping. Imaging of the treatment area may be accomplished as previously discussed. A path is then defined based on the mapped treatment area, according to step 1604. A track is produced for a massage apparatus, such as for the abdomen, based on the mapped path, according to step 1606. A stimulating mechanism is driven about the track to provide stimulation to the treatment area of a patient according to step 1608. A stimulating mechanism may be moved in a direction corresponding to the patient's large intestine according to step 1610. Engagement of the stimulating mechanism with the track is maintained using a guide mechanism according to step 1612. A variable mechanical pressure is applied to an abdomen of the patient having a variable treatment surface height based on the height of the track relative to the patient, according to step 1614.

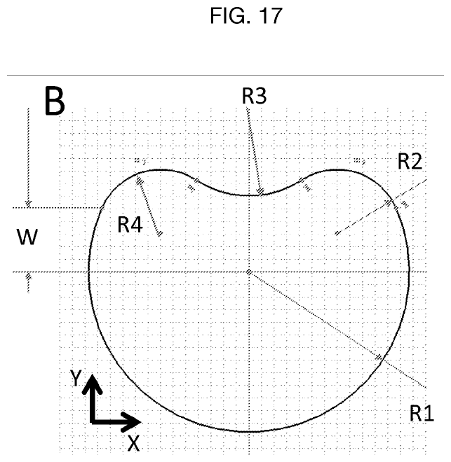

In the case where a patient has a mapped treatment area, a custom circuitous track having variable radius along the x- and y-axis may be produced relative to diagnostic or prominent points of the patient's body as previously discussed. The radius lines (shown as arrows R1, R2, R3, and R4 in FIG. 17) may be drawn from the anatomical landmarks located on the patient's body to position the custom track in relation to the patient's internal anatomy. Anatomical landmarks may be the diagnostic or prominent points such as bony prominences, center points of abdomen quadrants, anterior iliac spines, pubic symphysis, xiphoid process, or even the patient's belly button. The stimulating mechanism may be kept within the treatment area by having a clearance range of 5 mm to 15 mm (approx. ¼ inch to ½ inch) between the stimulating mechanism and the anatomical landmarks, this distance may depend upon the size of the stimulating mechanism. This may prevent discomfort of the patient by keeping the stimulating mechanism from passing over bony prominences such as the superior pubic region, anterior superior iliac spines (ASIS), and costal margins of the ribs. The track with relative height may be raised if the stimulating mechanism cannot maintain a course within the anatomical landmarks and will pass over bony prominences. This may decrease stimulating pressure for tender areas.

With a patient needing abdominal massage of the large intestine, the length of the radius line R1 may be measured from the belly button, the length of radius line R2 from the center of the upper-left quadrant, the length of radius line R3 from the xiphoid process, and the length of radius line R4 from the upper-right quadrant of a patient as shown in FIG. 17. In one case, a portion of the custom track may be placed 100 mm (approx. four inches) away from the belly button of a patient based on the length of radius line R1. The radius line R2 length for track placement may be 25 mm (approx. one inch) away from the center point of the upper-left quadrant. The radius line R3 length for track placement may be 50 mm (approx. two inches) away from the xiphoid process. The radius line R4 length for track placement may be 25 mm (approx. one inch) away from the center point of the upper-right quadrant. In another case, the custom track may be placed 125 mm (approx. five inches) away from the belly button of a patient based on the length of radius line R1. The radius line R2 length for track placement may be 25 mm (approx. one inch) away from the center point of the upper-left quadrant. The radius line R3 length for track placement may be 50 mm (approx. two inches) away from the xiphoid process. The radius line R4 length for track placement may be 25 mm (approx. one inch) away from the center point of the upper-right quadrant. The size, radii, the arcuate corners, and treatment surface area of the track may vary depending on the size of the track relative to patient parameters and measurements.

1. A massage apparatus comprising:
a track that is circuitous and sized proportional to a measurement of a patient;
a stimulating mechanism driven about the track; and
where the track is secured to a base having variable height and a thickness of the base affects a height of a corresponding track portion.

2. The massage apparatus of claim 1, where the measurement of the patient is a distance between a right anterior superior iliac spine (ASIS) of a pelvis and a left ASIS and the distance between a pubic symphysis and a xiphoid process.

3. The massage apparatus of claim 1, wherein the track further comprises:
a first track member that is arcuate;
an upper-mid track member that is arcuate and connected to the first track member;
a third track member that is arcuate and connected to the upper-mid track member;
a lower track member that is arcuate and connected to the third track member and the first track member; and
where a radius of the first track member and a radius of the third track member are less than a radius of a fourth track member.

4. The massage apparatus of claim 3, where the upper-mid track member has a radius that is proportional to a measured width of a patient's costal margin.

5. The massage apparatus of claim 3, where the lower track member has a radius proportional to a measured distance between a right anterior superior iliac spine (ASIS) and a left ASIS of a pelvis.

6. The massage apparatus of claim 3, wherein the first track member, the third track member, and the lower track member are convex and the upper-mid track member is concave.

7. The massage apparatus of claim 1, where the track is operable to be worn by the patient.

8. (canceled)

9. The massage apparatus of claim 1, further comprising:
a guide mechanism mounted to the stimulating mechanism, the guide mechanism engaged with the track to direct movement of the stimulating mechanism; and
a biasing mechanism disposed between the guide mechanism and the stimulating mechanism.

10. The massage apparatus of claim 9, where the stimulating mechanism is pivotally mounted to the biasing mechanism.

11. The massage apparatus of claim 1, where:
the track further comprises:
a first track portion having a first height from a treatment area of the patient; and
a second track portion having a second height from the treatment area of the patient, where the second height is different than the first height; and
the stimulating mechanism is operable to apply a first force to the patient at the first track portion based on the first height and to apply a second force at the second track portion based on the second height.

12. The massage apparatus of claim 11, where the second force is lower than the first force, and the second height is higher than the first height.

13. The massage apparatus of claim 12, where the second track portion corresponds to a generalized patient treatment location within at least one of a patient's superior pubic region, a costal margin, and an appendix.

14. A massage apparatus comprising:
a track that is circuitous and comprises:
a first track portion having a first height from a treatment area of a patient;
and
a second track portion having a second height from the treatment area of the patient, where the second height is different than the first height; and
a stimulating mechanism driven about the track
and resiliently biased toward the treatment area of the patient, where the stimulating mechanism is operable to apply a first force to the patient at the first track portion based on the first height and to apply a second force at the second track portion based on the second height.

15. The massage apparatus of claim 14, where the track is secured to a base having variable thickness.

16. The massage apparatus of claim 15, where the variable thickness of the base affects the height of a corresponding track portion.

17. The massage apparatus of claim 14, further comprising:
a drive mechanism; and
a first telescopic arm connecting a drive mechanism and a guide mechanism.

18. The massage apparatus of claim 17, where the first telescopic arm extends and retracts to radially position the stimulating mechanism based on a radial distance between the track and the drive mechanism.

19. The massage apparatus of claim 18, where the first telescopic arm is configured to extend outwardly to engage the guide mechanism with the track.

20. The massage apparatus of claim 14, further comprising:
a guide mechanism mounted to the stimulating mechanism and engaged with the track to direct movement of the stimulating mechanism.

21. The massage apparatus of claim 20, further comprising:
a drive mechanism connected to the guide mechanism, the drive mechanism operable to drive the drive mechanism and the stimulating mechanism upon the track.

22. The massage apparatus of claim 21, further comprising:
the guide mechanism mounted to the stimulating mechanism, the guide mechanism engaged with the track to direct movement of the stimulating mechanism; and
a biasing mechanism disposed between the guide mechanism and the stimulating mechanism.

23. The massage apparatus of claim 22, where the stimulating mechanism is pivotally mounted to the biasing mechanism.

24. The massage apparatus of claim 22, where the biasing mechanism is pivotally mounted to the guide mechanism.

25. The massage apparatus of claim 20, further comprising:
a drive mechanism connected to the guide mechanism and operable to drive the guide mechanism upon the track; and
where the drive mechanism, a biasing mechanism, and the stimulating mechanism are linearly aligned.

26. The massage apparatus of claim 14, where the stimulating mechanism is pivotable to offset the stimulating mechanism from the track relative to a patient's sagittal axis toward a center point of the track.

27. The massage apparatus of claim 14, where the stimulating mechanism is pivotable to offset the stimulating mechanism from the track relative to a patient's sagittal axis away from a center point of the track.

28. The massage apparatus of claim 14, where the massage apparatus is operable to be worn by the patient and the track is operable to be customized to the patient.

29. The massage apparatus of claim 14, further comprising:
a base upon which a frame is mounted, the base comprising:
a plurality of base mounts; and
where the frame further comprises:
a frame mount complimentary to the plurality of base mounts.

30. The massage apparatus of claim 14, further comprising:
a first riser having a first channel;
a second riser having a second channel; and
where the track is mounted to the first channel at a first riser height and to the second channel at a second riser height, and first riser height is different than the second riser.

31. The massage apparatus of claim 18, where a first riser and a second riser have a channel to receive the track.

32. The massage apparatus of claim 14, where the second force is lower than the first force, and the second height is higher than the first height.

33. The massage apparatus of claim 32, where the second track portion corresponds to a generalized patient treatment location within at least one of a patient's superior pubic region, a costal margin, and an appendix.

34. (canceled)

35. (canceled)

36. (canceled)

37. (canceled)

38. (canceled)
